(19) United States
(12) Patent Application Publication
(10) Pub. No.: US 2009/0012862 A1
(43) Pub. Date: Jan. 8, 2009

(54) INSTANT ZERO INVENTORY FULFILLMENT REDEMPTION SYSTEM AND METHOD

(75) Inventors: Carlo Pirillo, Mississauga (CA); Jonathan Gingerich, Toronto (CA); Maria Pallante, Brampton (CA); Anne Demy, Mississauga (CA)

Correspondence Address: SENNIGER POWERS LLP, 100 NORTH BROADWAY, 17TH FLOOR, ST LOUIS, MO, 63102, US

(73) Assignee: Maritz Inc., Fenton, MO (US)

(21) Appl. No.: 12/144,947

(22) Filed: Jun. 24, 2008

Related U.S. Application Data
(60) Provisional application No. 60/947,779, filed on Jul. 3, 2007.

(51) Int. Cl. G06Q 30/00

(52) U.S. Cl. 705/14

(57) ABSTRACT

An instant fulfillment system allows members of programs, such as an incentive, reward, affinity or loyalty program, to use an instant reward card to redeem currency or points stored in a database, for instant ‘rebates’ or ‘discounts’ at selected retailers.

### FIELD OF THE INVENTION

The present invention generally relates to systems and methods for allowing participants in a program such as an incentive, reward, affinity or loyalty program, to redeem points or other currency awarded to the participants by the program.

### BACKGROUND OF THE INVENTION

Prior redemption systems are not instantaneous because there is a delay from the time currency is earned and then awarded and then redeemable. In addition, such programs require the redemption system to have rewards in inventory in order to provide instant rewards.

### SUMMARY OF THE INVENTION

An instant fulfillment system allows members of programs, such as an incentive, reward, affinity or loyalty program, to use an instant reward card to redeem currency or points stored in a database for instant ‘rebates’ or ‘discounts’ at selected retailers. In general, it is contemplated that the database containing currency or points may or may not be part of the instant fulfillment system. Alternatively, or in addition, the system may interface to third party bank accounts and reconcile accordingly.

The system allows a system administrator operating a gateway to provide loyalty programs to a subscriber to their service or to a program owner with the ability to allow their members to redeem points (or established currency) stored in database instantly at a point of sale with an established retailer or retailers.

Other objects and features will be in part apparent and in part pointed out hereinafter.

### BRIEF DESCRIPTION OF THE DRAWINGS

FIG. 1 is a block diagram of one embodiment the system of the invention.

FIG. 2 is a block diagram illustrating the flow of information according to one embodiment of a method and/or system of the invention.

Corresponding reference characters indicate corresponding parts throughout the drawings.

### DESCRIPTION OF THE PREFERRED EMBODIMENTS

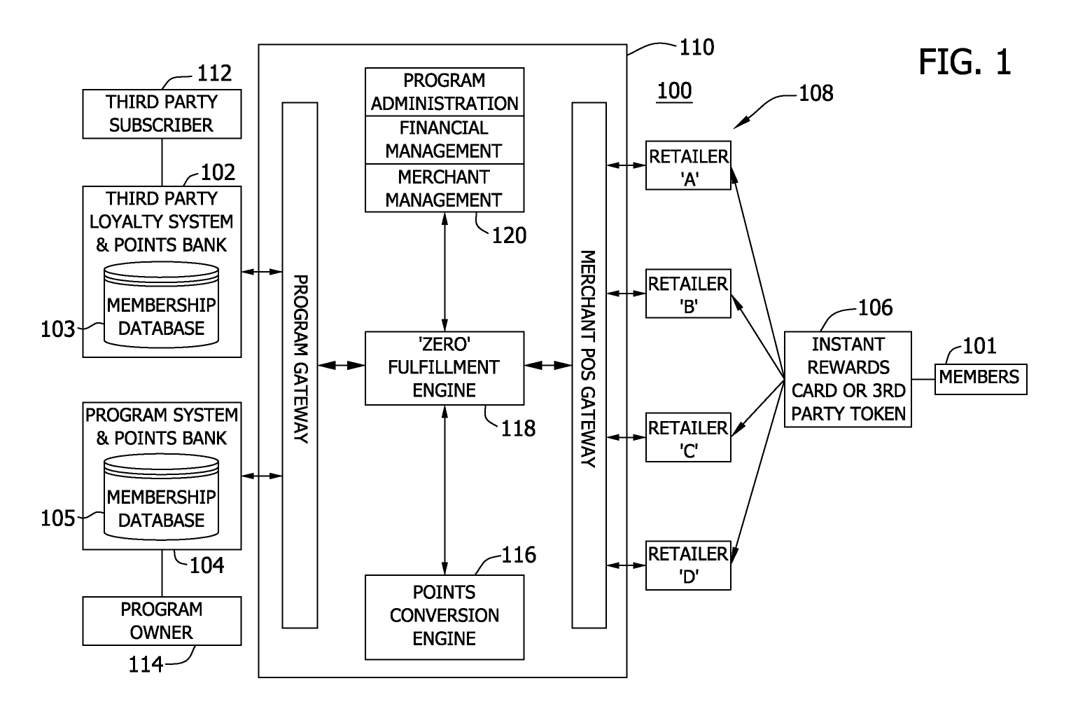

Referring to FIG. 1, a block diagram of one embodiment the system of the invention is illustrated. An instant fulfillment system 100 allows members 101 of programs 102, 104, such as an incentive, reward, affinity or loyalty program, to use an instant reward card 106 to redeem currency or points stored in a database 103, 105 for instant ‘rebates’ or ‘discounts’ at selected retailers 108. The system 100 allows a system administrator operating a gateway 110 to provide loyalty programs 102, 104 to a subscriber 112 to their service or to a program owner 114 with the ability to allow their members 101 to redeem points (or established currency) stored in database 103, 105 instantly at a point of sale with an established retailer or retailers 108. A membership card or identification token 106, issued either by the third party loyalty subscriber 112, the program owner 114 or by the system administrator, can be ‘swiped’ (e.g., input) at authorized retailers 106. A unique ID will provide access to the members 101 account status through the gateway 110 operated by the system administrator. Once a redemption request (in dollars) has been submitted to the gateway 110, a points conversion engine 116 will calculate the equivalent points value for the specified program (e.g., the engine 116 converts currency to points and points to currency). A zero fulfillment redemption engine 118 will reconcile the member redemption with the subscriber 112 and/or the program owner 114, deducting the redeemed points value from the account in the database 103, 105 and confirming with the retailer 108 that the rebate has been successfully processed. In one embodiment, the zero fulfillment redemption engine 118 comprises one or more interfaces configured to communicate with the various loyalty systems 102 and program systems 104 in order to instantly accomplish the transaction. Thus, members 101 may conduct redemption transactions with currency retailers 108 (e.g., in cash, debit, credit) instantly by using their points. As a result, the members 101 redeem their points for purchased products or services and the loyalty systems 102 and program systems 104 have zero inventory for fulfilling the redemption transactions. This system allows zero inventory for fulfillment because the merchants 108 provide the products or services in exchange for the redeemed points, providing fulfillment. On an established frequency, the system administrator will reconcile with the retailer 108 for all processed transactions.

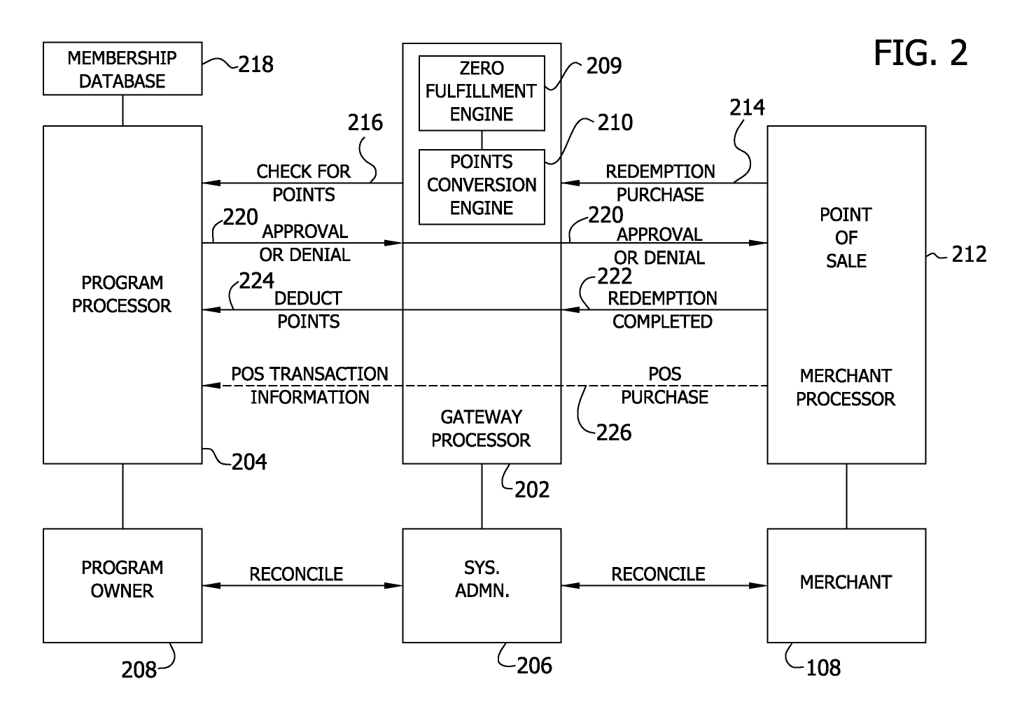

Referring to FIG. 2, the system of the present invention is illustrated as a block diagram showing the flow of information. In this illustration, a gateway processor 202 and a program processor 204 are presented as separate components. However, it is contemplated that these two components may be combined.

For example, a system administrator 206 may be implementing a program 102, 104 for a program owner 208 and may be operating both the program 102, 104 and the gateway 110 as an integrated component. In this example, the gateway 110 would process the redemption request by submitting it to a fulfillment engine 209 for interfacing with a program processor 204 via a points conversion engine 210 which converts the transaction to the currency of the member accounts (e.g., points) and which confirms that the account is in good standing with sufficient balance. If all is clear, the redemption is completed and a confirmation transaction is sent via the gateway 110 to the merchant 108. The return transaction information may include status information and confirmation of the transaction, current member account status and current member balance.

As another example, a preexisting program (102, 104) having a program processor 204 may be linked to merchant processors 212 via the gateway processor 202 to implement the system 100 of the invention. In this configuration, the program processor 204 manages the program awarding currency to program members 101. The merchant processor 212 processes POS transactions of the merchant 108 and the gateway processor 202 interfaces between the program processor 204 and the merchant processor 212. The merchant processor 212 provides to the gateway processor 202 redemption purchase information 214 initiating a redemption purchase by the member. This information may include a program ID (from the member's token 106), a membership ID or member account (from the member's token 106) and a redemption value. The gateway processor 210 employs the points conversion engine 210 to generate the program processor 204 redemption points information 216 corresponding to the redemption purchase information. The zero fulfillment engine 209 provides the resulting transaction information (in points) to the program processor 204. The program processor 204 compares the member's account balance in a membership database 218 and the redemption points information 216. The program processor 204 provides approval information 220 via engine 209 to the gateway processor 202 when the member's account balance is sufficient for the redemption purchase. Next, the zero fulfillment engine 209 provides the approval information 220 received from the program processor 204 to the merchant processor 212. The merchant processor 212 then completes the transaction (in cash) in response to the approval information 220 from the gateway processor 202 and provides redemption completion information 222 to the engine 209 of the gateway processor 202. Next, the engine 209 provides points deduction information 224 to the program processor 204 in response to the redemption completion information 222. The program processor 204 in response to the points deduction information 224 from the gateway processor 202 deducts points corresponding to the redemption points information 216 from the member's account in database 218 to complete the transaction in points.

In one optional embodiment, the card or token 106 may be used to earn points or currency at the time of purchase. For example, the card 106 may be a credit or debit card. The merchant processor 212 would provide POS purchase information 226 for each particular transaction using such a card 106 for purchases (e.g., cash, credit or debit) by the member 101. The information 226 is provided to the gateway processor 202. In response, the gateway processor 202 provides the POS transaction information 226 for each such transaction to the program processor 204. In response, the program processor 204 debits an award (e.g., of points or currency) earned to the member's account in database 218 in response to the POS transaction information 226.

In one embodiment, when the program processor 204 compares the member's account balance in database 218 and the redemption points information 214, the program processor provides denial information 220 to the gateway processor 220 when the member's account balance is insufficient for the redemption purchase. In response, the gateway processor 202 provides the denial information 220 received from the program processor to the merchant processor 212. The merchant processor 212 cancels the transaction in response to the denial information 220.

Alternatively or in addition, the program may be managed by the program owner 208 and the gateway processor 202 is managed by the system administrator 206. Completed transactions are reconciled between the program owner 208 and the merchant 108 via the system administrator 206.

Alternatively or in addition, the program may be managed by the program owner 208, in which case completed transactions are reconciled between the program owner 208 and the merchant.

In one embodiment, part of the redemption purchase is paid for by the member with other than currency from the member's account.

Aspects of the present invention are directed to the following process including program participation and registration, redemption and reconciliation:
Program Participation & Registration
   Loyalty program owner joins gateway (could be existing 3^{rd} party program, new 3^{rd} party program, or program already managed and executed by the system administrator;
   Loyalty token identification range bin registered in gateway;
   Rebated levels and points conversion rates registered in gateway
   Linkages POS, Payment established with system administrator
Redemption
   Member visits participating merchant
   Member selects items and proceeds to checkout
   Member requests rebate, amount and presents token
   Merchant swipes token and initiates at POS redemption
   Redemption request sent to gateway
   Gateway confirms account status, completes points conversion, debits points from account and completed transaction
   Gateway sends redemption confirmation to merchant POS
   Merchant confirms rebate and completes checkout
   Member has successfully redeemed points instantly at point of sale
Reconciliation
   Gateway reconciliates with merchant as per agreement
   Gateway reconciliates with program owner as per agreement

Some benefits of the system and method of the invention include:
Instant gratification for Members
Increased Member engagement
Increased brand exposure
Cost effective redemption
Supports expansion and diversification of rewards
Encourages accumulation partner participation
Environmentally friendly by eliminating the need for disposal gift cards

In one embodiment, the system comprises the program processor 204 managing the program awarding currency to the program member 101, the merchant processor 212 processing POS transactions of the merchant 108 and the gateway processor 202 interfacing between the program processor 204 and the merchant processor 212.

The merchant processor 212 provides to the gateway processor 202 redemption purchase information 214 initiating a redemption purchase by the member. The gateway processor 202 provides to the program processor 204 redemption points information 216 corresponding to the redemption purchase information 214. The program processor 204 compares the member's account balance and the redemption points information 216 and provides approval information 220 to the gateway processor 202 when the member's account balance (e.g. in database 218) is sufficient for the redemption purchase. The gateway processor 202 provides the approval information 220 received from the program processor 204 to the merchant processor 212. The merchant processor 212 completes the transaction in response to the approval information from the gateway processor 202 and provides redemption completion information 222 to the gateway processor 202. The gateway processor 202 provides points deduction information 224 to the program processor 204 in response to the redemption completion information 222. The program processor 204 in response to the points deduction information 224 from the gateway processor 202 deducts points corresponding to the points deduction information 224 from the member's account.

In one embodiment, the merchant processor 204 provides POS transaction information 226 to the gateway processor 202 regarding purchases by the member, the gateway processor 202 provides the POS transaction information 226 to the program processor 204 and the program processor 204 debits an award to the member's account in response to the POS transaction information 226.

In one embodiment, when the program processor 204 compares the member's account balance and the redemption points information 216, the program processor 204 provides denial information 220 to the gateway processor 202 when the member's account balance is insufficient for the redemption purchase, the gateway processor 202 provides the denial information 220 received from the program processor 204 to the merchant processor 212, and the merchant processor 212 cancels the transaction in response to the denial information 220.

In one embodiment, the program is managed by the program owner 208 and the gateway processor 202 is managed by the system administrator 206. Completed transactions are reconciled between the program owner 208 and the merchant 108 via the system administrator 206.

In one embodiment, the program is managed by a program owner 208 and completed transactions are reconciled between the program owner 208 and the merchant 108.

In one embodiment, part of the redemption purchase is paid for by the member 101 with other than currency from the member's account (e.g. supplemental cash or credit).

Thus, in one embodiment, the invention comprises a method of computer executable instructions, stored on a tangible computer readable storage medium, as illustrated in FIG. 2, for execution by the gateway processor 202 for the program awarding currency to the program member 101, the method comprising:
receiving from the merchant processor 204 redemption purchase information 214 initiating a redemption purchase by the member 101;
providing to the program processor 204 redemption points information 216 corresponding to the redemption purchase information 214 wherein the program processor 204 compares the member's account balance (e.g., in database 218)and the redemption points information 216;
receiving from the program processor 204 approval information 220 when the member's account balance is sufficient for the redemption purchase;
providing the approval information 220 received from the program processor 204 to the merchant processor 212 wherein the merchant processor 212 completes the transaction in response to the approval information 220 and provides redemption completion information 222; and
receiving the redemption completion information 222 and providing points deduction information 224 to the program processor 204 in response to the redemption completion information 222 wherein the program processor 204 in response to the points deduction information 224 deducts points corresponding to the points deduction information 224 from the member's account.

For purposes of illustration, programs and other executable program components, such as instructions may be illustrated herein as discrete blocks. It is recognized, however, that such programs and components reside at various times in different storage components of the computer, and are executed by the data processor(s) of the computer.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A system comprising:
a program processor managing a program awarding currency to a program member;
a merchant processor processing POS transactions of a merchant;
a gateway processor interfacing between the program processor and the merchant processor, wherein:
the merchant processor provides to the gateway processor redemption purchase information initiating a redemption purchase by the member;
the gateway processor provides to the program processor redemption points information corresponding to the redemption purchase information;
the program processor compares the member's account balance and the redemption points information, said program processor providing approval information to the gateway processor when the member's account balance is sufficient for the redemption purchase;
the gateway processor provides the approval information received from the program processor to the merchant processor;
the merchant processor completes the transaction in response to the approval information from the gateway processor and provides redemption completion information to the gateway processor;
the gateway processor provides points deduction information to the program processor in response to the redemption completion information; and
the program processor in response to the points deduction information from the gateway processor deducts points corresponding to the points deduction information from the member's account.

2. The system of claim 1 wherein:
the merchant processor provides POS transaction information to the gateway processor regarding purchases by the member;
the gateway processor provides the POS transaction information to the program processor; and
the program processor debits an award to the member's account in response to the POS transaction information.

3. The system of claim 1 wherein:
when the program processor compares the member's account balance and the redemption points information, said program processor provides denial information to the gateway processor when the member's account balance is insufficient for the redemption purchase;
the gateway processor provides the denial information received from the program processor to the merchant processor; and
the merchant processor cancels the transaction in response to the denial information.

4. The system of claim 1 wherein the program is managed by a program owner and the gateway processor is managed by a system administrator and wherein completed transactions are reconciled between the program owner and the merchant via the system administrator or wherein the program is managed by a program owner and wherein completed transactions are reconciled between the program owner and the merchant.

5. The system of claim 1 wherein the gateway processor comprises a points conversion engine for converting currency to points and points to currency and a zero fulfillment engine for interfacing with the program processor.

6. The system of claim 1 wherein part of the redemption purchase is paid for by the member with other than currency from the member's account.

7. A method for execution by a gateway processor for a program awarding currency to a program member, said method comprising:
receiving from a merchant processor redemption purchase information initiating a redemption purchase by the member;
providing to a program processor redemption points information corresponding to the redemption purchase information wherein the program processor compares the member's account balance and the redemption points information;
receiving from said program processor approval information when the member's account balance is sufficient for the redemption purchase;
providing the approval information received from the program processor to the merchant processor wherein the merchant processor completes the transaction in response to the approval information and provides redemption completion information; and
receiving the redemption completion information and providing points deduction information to the program processor in response to the redemption completion information wherein the program processor in response to the points deduction information deducts points corresponding to the points deduction information from the member's account.

8. The method of claim 7 further comprising receiving from the merchant processor POS transaction information regarding purchases by the member; and providing the POS transaction information to the program processor wherein the program processor debits an award to the member's account in response to the POS transaction information.

9. The method of claim 7 wherein when the program processor compares the member's account balance and the redemption points information, said program processor provides denial information to the gateway processor when the member's account balance is insufficient for the redemption purchase; and further comprising:
providing the denial information received from the program processor to the merchant processor wherein the merchant processor cancels the transaction in response to the denial information.

10. The method of claim 7 wherein the program is managed by a program owner and method is managed by a system administrator and wherein completed transactions are reconciled between the program owner and the merchant via the system administrator.

11. The method of claim 7 wherein the program is managed by a program owner and wherein completed transactions are reconciled between the program owner and the merchant.

12. The method of claim 7 wherein part of the redemption purchase is paid for by the member with other than currency from the member's account.

13. A system for use with a program processor managing a program awarding currency to a program member, and for use with a merchant processor processing POS transactions of a merchant; said system comprising:
a gateway processor interfacing between the program processor and the merchant processor, wherein:
the merchant processor provides to the gateway processor redemption purchase information initiating a redemption purchase by the member;
the gateway processor provides to the program processor redemption points information corresponding to the redemption purchase information;
the program processor compares the member's account balance and the redemption points information, said program processor providing approval information to the gateway processor when the member's account balance is sufficient for the redemption purchase;
the gateway processor provides the approval information received from the program processor to the merchant processor;
the merchant processor completes the transaction in response to the approval information from the gateway processor and provides redemption completion information to the gateway processor;
the gateway processor provides points deduction information to the program processor in response to the redemption completion information; and
the program processor in response to the points deduction information from the gateway processor deducts points corresponding to the points deduction information from the member's account.

14. The system of claim 13 wherein:
the merchant processor provides POS transaction information to the gateway processor regarding purchases by the member;
the gateway processor provides the POS transaction information to the program processor; and
the program processor debits an award to the member's account in response to the POS transaction information.

15. The system of claim 13 wherein:
when the program processor compares the member's account balance and the redemption points information, said program processor provides denial information to the gateway processor when the member's account balance is insufficient for the redemption purchase;
the gateway processor provides the denial information received from the program processor to the merchant processor; and
the merchant processor cancels the transaction in response to the denial information.

16. The system of claim 13 wherein the program is managed by a program owner and the gateway processor is managed by a system administrator and wherein completed transactions are reconciled between the program owner and the merchant via the system administrator.

17. The system of claim 13 wherein the program is managed by a program owner and wherein completed transactions are reconciled between the program owner and the merchant.

18. The system of claim 13 wherein part of the redemption purchase is paid for by the member with other than currency from the member's account.
